(19) United States
(12) Patent Application Publication
(10) Pub. No.: US 2026/0194987 A1
(43) Pub. Date: Jul. 9, 2026

(54) CONTEXTUAL SIGNAL-BASED WEARABLE DEVICE WAKE-UP FRAMEWORK

(71) Applicant: GOOGLE LLC, Mountain View, CA (US)

(72) Inventors: Dongeek Shin, San Jose, CA (US); Anuva Kulkarni, Santa Clara, CA (US)

(21) Appl. No.: 19/130,740

(22) PCT Filed: Nov. 17, 2022
(86) PCT No.: PCT/US2022/080029

§ 371 Date: May 16, 2025

(51) Int. Cl. G06F 3/02; G06N 3/0442; G06N 3/0464

(52) U.S. Cl. CPC G06F 3/02; G06N 3/0442; G06N 3/0464

(57) ABSTRACT

A method including sensing, by a wearable device, device context as a contextual cue, selecting, by the wearable device, a trained input model based on the contextual cue, generating, by the wearable device, a feature representation based on a wake-up cue using the input model, and predicting, by the wearable device, a wake-up trigger based on the feature representation.

### FIELD

Embodiments relate to using machine learned models to wake-up a wearable device that is in a sleeping (e.g., power usage minimization) state.

### BACKGROUND

Wearable devices (e.g., smart glasses, augmented reality (AR) glasses, head mounted AR device, smart rings, smart watches, and the like) can enter a sleep or inactive state or mode in order to conserve power (e.g., battery use) when the wearable device is not actively in use. The wearable device can include a framework (e.g., hardware and software) used to wake-up (e.g., switch to an active state or mode) the wearable device in response to a user action (e.g., user input).

### SUMMARY

Example implementations can implement a machine learning model for detecting a wake-up signal for a wearable device. The machine learning model can vary based on a contextual cue such that a complex machine learning model that uses more power (e.g., battery usage) can be used in a dynamic contextual situation and a less complex machine learning model that uses less power (e.g., battery usage) can be used in a static contextual situation. Varying the machine learning model can include varying an input model in order to minimize battery and memory usage for the machine learning model on the wearable device.

In a general aspect, a device, a system, a non-transitory computer-readable medium (having stored thereon computer executable program code which can be executed on a computer system), and/or a method can perform a process with a method including sensing, by a wearable device, device context as a contextual cue, selecting, by the wearable device, an input model of a neural network based on the contextual cue, generating, by the wearable device, a feature (e.g., feature vector) representation based on a wake-up cue using the input model, and predicting, by the wearable device, a wake-up trigger based on the feature representation.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a block diagram of a wake-up framework of a wearable device according to an example implementation.

FIG. 1B illustrates a signal diagram of a wake-up signal associated with a wearable device according to an example implementation.

FIG. 1C illustrates a block diagram of a wake-up machine learning model of a wearable device according to an example implementation.

FIG. 2 machine learning model of a wearable device according to an example implementation.

FIG. 3A illustrates an example head mounted wearable device worn by a user according to an example implementation.

FIG. 3B is a front view, and FIG. 3C is a rear view of the example wearable device shown in FIG. 3A according to an example implementation.

FIG. 4 illustrates a block diagram of a system according to an example implementation.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Some wearable devices (e.g., smart glasses, AR glasses, head mounted AR device, smart rings, smart watches, and the like) have a unique property that the devices can be always-on and can gain full world context from the perspective of user (e.g., wearing the device). However, a challenge with regard to wearable devices can be to ensure that the battery is capable of providing power for the wearable device for at least a day with full usage. This can be difficult with the always-on perception elements.

Example implementations described herein can include a framework configured to control wearable device input, specifically the wake-up signal. The wake-up signal can be sensed based on variable sensor rate dependent, pre-trained neural networks, using always-on contextual cues. For example, using an always-on camera, the wearable device can monitor contextual cues associated with the wearable device. For example, a user of the wearable device may be determined to be relatively static (e.g., sitting and working) based on images and/or video captured by the always-on camera. Therefore, detecting the wake-up signal (e.g., double tapping on the side of glasses using the IMU sensor data) may not have to be aggressive in determining a false positive rejection because the contextual cues indicates that it may be unlikely that a false positive has occurred.

As another example, the user of the wearable device may be determined to be relatively dynamic. For example, if images and/or video captured by the always-on camera includes a dashboard of a car, the acceleration from the car can be determined to interfere with the wake-up signal. Therefore, the contextual cue can indicate a relatively high possibility (as compared to a static context) of a false positive rejection of the wake-up signal. Therefore, detecting the wake-up signal can include initiating the use of a higher frame rate (of the always-on camera) to improve a dynamic range to contain relevant movement. In this example, a higher frame rate can be more aggressive in determining false positive rejection.

Example implementations can use contextual cues to improve and/or reduce the battery utilization and improve the user experience by improving and/or increasing wake-up determination performance. In other words, the use of contextual cues in the wake-up determination can ensure that just enough processing is used to determine that the wearable device should wake-up. Just enough processing can be using an increased amount of processing (e.g., high-power wake) in situations where the likelihood of a false positive for wake-up is relatively high and using a decreased amount of processing (e.g., low-power wake) in situations where the likelihood of a false positive for wake-up is relatively low. Using a decreased amount of processing can result in minimizing battery usage and increasing the battery charge life.

In an example implementation, a machine learning model can be used for detecting the wake-up signal. The machine learning model can be a variable model. For example, the machine learning model can vary based on a contextual cue. Varying the machine learning model can include having a first variation(s) that implements a relatively low-power wake-up and a second variation(s) that implement a relatively high-power wake-up (and a plurality of variations in-between). The variable machine learning models can be mapped from one to another in runtime without storing all models explicitly on a memory of the wearable device. For example, input model scaling can be used. For example, the variable machine learning models can share models of classification (e.g., fully connected layers) configured to make a wake-up determination (e.g., prediction) and have a variable (e.g., per-model convolutional layers) selected based on the contextual cue.

Variable input models with fixed classification models can save memory without compromising accuracy during context and machine learning model switching. A model (e.g., the variable input model can also be a layer of a model. However, for simplicity a model will be used herein to refer to a model and/or a layer of a model. Further, a model can be machine learning model, a trained model, a neural network, a trained neural network and/or the like.

The below described wearable devices can be, for example, smart glasses, AR glasses, head mounted AR device, smart rings, smart watches, and the like. However, smart glasses or AR glasses are illustrated for clarity. Other wearable devices that include a wake-up framework (e.g., that can be switched from an inactive state to an active state) are within the scope of this disclosure.

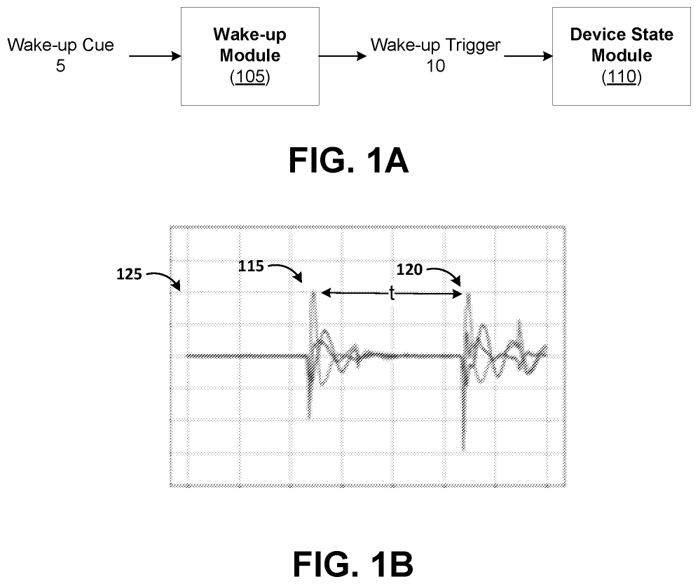

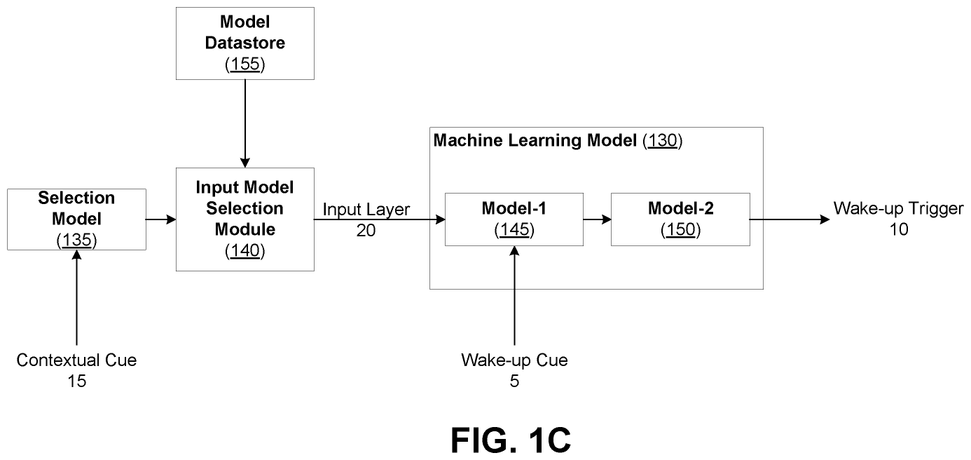

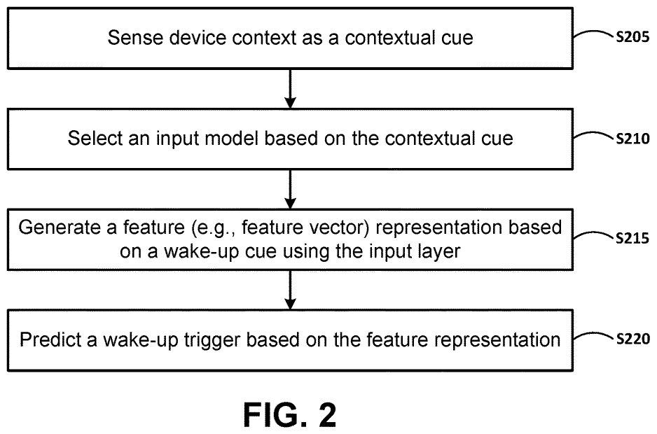

FIG. 1A illustrates a block diagram of a wake-up framework of a wearable device according to an example implementation. As shown in FIG. 1A, the wake-up framework includes a wake-up module 105 that takes a wake-up cue 5 as input and can generate a wake-up trigger 10 based on the wake-up cue 5. The wake-up trigger 10 can be input to a device state module 110. The device state module 110 can be configured to cause the wearable device to transition between two states. In an example implementation, the two states can be an inactive state (herein also called a sleep state or inactive mode) and an active state (herein also called an awake state or active mode). The device state module 110 can be configured to cause the wearable device to transition from the awake state to the sleep state in response to the wearable device inactivity and/or in response to a user action.

The device state module 110 can be configured to cause the wearable device to transition from the sleep state to the awake state in response to the wearable device activity and/or in response to a user action. The user action can include double tapping on the wearable device. The double tapping can cause a sensor of the wearable device to generate a wake-up signal. FIG. 1B illustrates a signal diagram of a wake-up signal associated with a wearable device according to an example implementation. The double tapping can cause the sensor to generate the wake-up signal including two responses. A first response 115 can be generated in response to a first tap and a second response 120 can be generated in response to a second tap. The two responses 115, 120 can be the wake-up cue 5.

In an example implementation, the wake-up cue 5 can be a sensed double tap of the wearable device, a movement (e.g., turn, twist, shake, and the like) of the wearable device, location of the wearable device and/or the like. For example, the sensed double tap can include a sensed first tap and a sensed second tap. A sensed tap can correspond to each of the two responses 115, 120. Further, the wake-up trigger 10 can be based on (e.g., predicted) a time period t between the sensed first tap (e.g., corresponding to the first response 115) and the sensed second tap (e.g., corresponding to the second response 120).

In an example implementation, the wake-up module 105 can generate the wake-up trigger 10 only when the wake-up cue 5 is a true or positive wake-up signal. However, there is the possibility that the wake-up module 105 can generate the wake-up trigger 10 when the wake-up cue 5 is a false or false positive wake-up signal. Therefore, in example implementations, the wake-up module 105 can be configured to determine not to generate the wake-up trigger 10 when the wake-up cue 5 is a false or false positive wake-up signal. This is sometimes called a false positive rejection. The false positive rejection can conserve wearable device battery by not waking the wearable device when the wake-up cue 5 is a false or false positive wake-up signal. As an example, a false or false positive wake-up signal can include two responses 115, 120. However, in order to be determined to be a true or positive wake-up signal, the two responses 115, 120 should be above a threshold amplitude 125. If one or both of the two responses 115, 120 are not above the threshold amplitude 125, the wake-up cue 5 can be determined to be a false or false positive and the wake-up module 105 can be configured to not generate the wake-up trigger 10. The wake-up module 105 can be configured to be more or less aggressive in determining a false positive rejection based on the context (e.g., environment) in which the wearable device is being used.

In an example implementation, the wake-up module 105 can include a machine learning model. FIG. 1C illustrates a block diagram of a wake-up machine learning model of a wearable device according to an example implementation. As shown in FIG. 1C, a machine learning model 130 can include a model-1 145 and a model-2 150. In addition, FIG. 1C illustrates a selection model 135, an input model selection module 140 and a model datastore 155.

The selection model 135 can be configured to determine the context of the wearable device based on a contextual cue 15. The context can be used by the input model selection module 140 to select an input model 20 from the model datastore 155. The selected input model 20 can be used as the model-1 145. The model-1 145 can be configured as an input model (e.g., a ML model) to process the wake-up cue 5. The model-2 150 can be configured to generate (e.g., predict) the wake-up trigger 10 based on the output of model-1 145. Accordingly, wake-up trigger 10 can be generated using the machine learning model 130 based on the wake-up cue 5 and the contextual cue 15.

The selection model 135 can be a trained ML model configured to identify the environment. In order to identify an environment, a computer vision model can be trained using images of objects that can be found in various environments. The image captured by an always-on camera of the wearable device. The images include images of static and/or dynamic environments. For example, the images can include desks, chairs, bookshelves, computers and/or the like for environment (e.g., an office). The images can include trees, vegetation, grass, automobile, automobile interiors, buildings and/or the like for a dynamic (e.g., outdoor) environment. An image captured by an always-on camera of the wearable device can be included in the contextual cue 15. The contextual cue 15 can also be based on motion of the wearable device. Motion detection can correspond to measurements of an accelerometer. In an example implementation, the wearable device can include an inertial measurement unit (IMU). The IMU (e.g., an always-on IMU) can be configured to measure and report velocity, orientation, and gravitational forces, using, for example, a combination of sensors (accelerometers, gyroscopes and magnetometers). For example, the IMU can report pitch, yaw, and roll. Therefore, the IMU can be used for three (3) degrees of freedom (3DoF) movement measurements.

The contextual cue 15 can be based on images, video, and/or motion. Therefore, the selection model 135 can be and/or include a trained ML model configured to identify the environment based on the contextual cue 15, for example, images, video, and/or IMU data (e.g., motion). Selection model 135 can additionally and/or alternatively include a deterministic model configured to identify the environment based on the contextual cue 15, for example, images, video, and/or IMU data (e.g., motion). For example, the selection model 135 can identify an image as being the interior of an automobile and identify IMU indicating a change in velocity. The selection model 135 can predict that the wearable device is contextually in a moving automobile. A moving automobile can indicate a dynamic contextual situation.

The model-1 145 can be configured as (or include) an input model (e.g., a ML model or a portion of a ML model) to process the wake-up cue 5. An input model can be configured for feature extraction on input data. Therefore, model-1 145 can be configured to extract features from the wake-up cue 5. The extracted features can be associated with tapping (e.g., single tap, double tap, and/or the like). Therefore, the features can be audio signals (e.g., from a speaker), vibration signals (e.g., from a speaker or a piezoelectric sensor), and the like. The wake-up cue can be an electric (e.g., impulse(s)) signal. Therefore, the extracted features can be measured electrical characteristics including, for example, power, amplitude, timespan, pattern (e.g., wave pattern), and the like. The model-1 145 can be and/or include a neural network (or a portion thereof). For example, the model-1 145 can be and/or include a convolutional neural network (CNN). Therefore, the model-1 145 can be trained to generate or extract features from or based on the wake-up cue 5. In other words, the model-1 145 can be and/or include a trained neural network model (e.g., a CNN). Training the model-1 145 can include using user sessions and ground-truth data for the user sessions. As discussed above, the model-1 145 can be used and/or trained based on a static and/or dynamic environments.

The model-2 150 can be configured to determine whether or not the wearable device should be transitioned from an inactive state (e.g., asleep) to an active state (e.g., awake). In other words, the model-2 150 can be configured to generate the wake-up trigger 10 in response to determining that the wearable device is to be transitioned from an inactive state (e.g., asleep) to an active state (e.g., awake). For example, the model-2 150 can be configured to predict the wake-up trigger 10 based on the features extracted by model-1 145. Therefore, the wake-up trigger 10 can be based on (e.g., predicted based on) the wake-up cue 5. The model-2 150 can be and/or include a neural network (or a portion thereof). For example, the model-2 150 can be and/or include a CNN, an LSTM, and/or the like. Therefore, the model-2 150 can be trained to predict the wake-up trigger 10 based on the features extracted by model-1 145. Training the model-1 145 and/or the model-2 150 can include using user sessions and ground-truth data for the user sessions.

The machine learning model 130 can be and/or include a CNN Long Short-Term Memory (LSTM) model. A CNN LSTM can include a CNN model on the front end and an LSTM model with a dense layer on the output. In other words, the CNN LSTM can include two models or layers. The CNN model or layer can be configured for feature extraction and the LSTM model or layer for interpreting the features across time steps. Therefore, model-1 145 can be a CNN and model-2 150 can be a LSTM.

The CNN model may only process a single input signal, transforming the input signal into an internal matrix or vector representation (e.g., feature representation, feature vector representation, and/or the like). Therefore, the CNN model or operation may be performed across multiple input signals which can allow the LSTM to build up internal state and update weights using backpropagation through time (BPTT) across a sequence of the internal vector representations of the input signals. For example, there can be a single CNN model and a sequence of LSTM models, one for each time step. The CNN model can be applied to each input signal and pass on the output of each input signal (e.g., features) to the LSTM as a single time step.

The model datastore 155 can include a plurality of input models that can be selected as input model 20. Each of the plurality of input models can be configured to sense the wake-up cue 5. Each of the plurality of input models can be configured to sense the wake-up cue with a different time step for processing the wake-up cue 5. The different time steps can be based on whether the context cue 15 is static or dynamic. In an example implementation, the model datastore 155 includes a plurality of CNN models (that can be selected by the input model selection module 140). Each of the CNN models can be differentiated based on the time step. In other words, for static contexts (e.g., based on context cue 15), a CNN can have a long time step resulting in a minimal amount of processed input signals which can minimize (e.g., save) battery resources.

By contrast, for dynamic contexts (e.g., based on context cue 15), a CNN can have a short time step resulting in a larger number of processed input signals which can use more battery resources. For example, as discussed above, the wake-up cue 5 can be a sensed double tap of the wearable device. Therefore, the CNN, as model-1 145, can be trained to extract or generate features based on a sensed first tap (e.g., corresponding to the first response 115), to extract or generate features based on a sensed a second tap (e.g., corresponding to the second response 120) and extract or generate features based on the time t. Further, the LSTM, as model-2 150, can be configured to build up an internal state and update weights by accumulating the features based on the sensed first tap, then the features based on the time t, and finally the features based on the sensed first tap.

Training the CNN can include receiving a training wake-up cue session including a plurality of possible wake-up cues. For example, the wake-up cue session can include a plurality of single taps, double taps, noise, background signals, and/or the like. As mentioned above, the wake-up cue 5 that can cause the generation of the wake-up trigger 10 can be a double tap. Therefore, the training can also include windowing the training wake-up cue session to generate a windowed wake-up cue and determining whether the windowed wake-up cue includes a double tap signal. In response to determining the windowed wake-up cue includes the double tap signal, the CNN can be trained using the windowed wake-up cue.

The model datastore 155 can be included in a remote device that is communicatively coupled with the wearable device. For example, the remote device can be a server that is wired and/or wirelessly communicatively coupled with the wearable device. By including the model datastore 155 in a remote device, the model datastore 155 may not use memory on the wearable device. Thus, conserving memory while allowing for a variable input model (e.g., model-1 145).

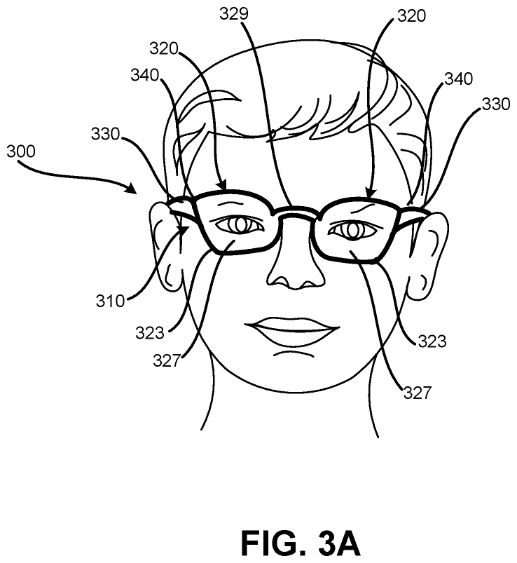

FIG. 2 machine learning model of a wearable device according to an example implementation. As shown in FIG. 2, in step S205 device context is sensed as a contextual cue. For example, an always-on camera of the wearable device can be periodically capturing images. Each of (or a portion of) the periodically capturing images can be the captured image used as the contextual cue. For example, additionally and/or alternatively, an always-on IMU can periodically sense, for example, velocity and/or movement of the wearable device. Each of (or a portion of) the periodically sensed IMU data can be used as the contextual cue. In an example implementation, an image and/or IMU data can be used as the contextual cue.

In step S210 an input model, for example, of a neural network is selected based on the contextual cue. For example, as discussed above, the contextual cue can be used to help determine whether the wearable device is in a static context or a dynamic context (or varying degrees of each). The context can then be used for selecting one of a plurality of variable rate models (e.g., variable sampling rate). The selected one of the plurality of variable rate models can be used as the input model of a machine learning model (e.g., a CNN LSTM model).

In step S215 a feature (e.g., a feature vector) representation is generated based on a wake-up cue using the input model. For example, the input model of the neural network can be used to extract features associated with the wake-up cue (e.g., double tap, turn, twist, and/or the like). The extracted features can correspond to the feature representation. In other words, the feature representation can be a vector representation of features or feature vector representation extracted from the wake-up cue. In an example implementation, the input model can be a CNN. Therefore, the feature representation (e.g., feature vector) can be generated by the CNN.

In step S220 a wake-up trigger is predicted based on the feature representation. Note that, if instead of a wake-up cue being input to the input model, some other signal (e.g., background or noise) is input to the input model, no wake-up cue can be predicted. For example, if the wake-up cue is a double tap, the wake-up trigger is predicted. In an example implementation, an output model can be a LSTM. Therefore, the wake-up trigger can be predicted can be generated by the LSTM. In this way, a wake-up trigger can be predicted based on a contextual cue and a wake-up cue, where the contextual cue is used to select a variable rate (e.g., variable sensor sample rate) model.

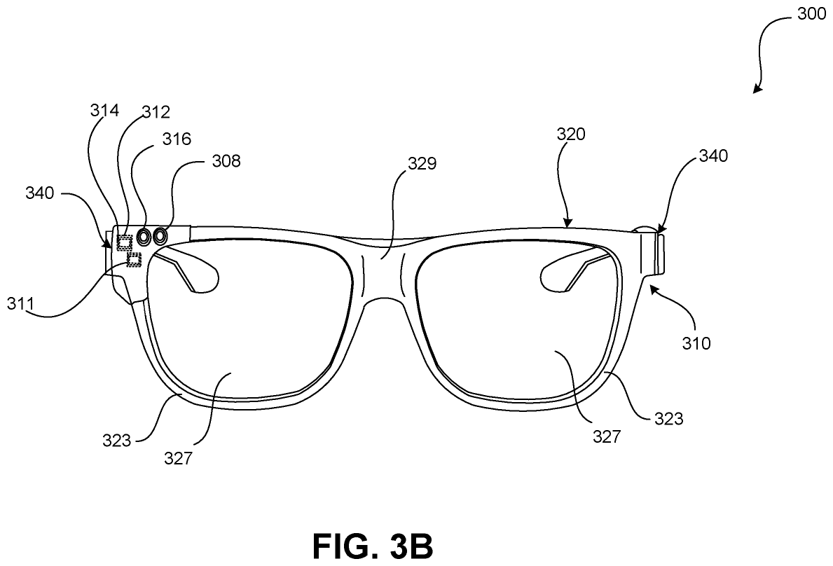

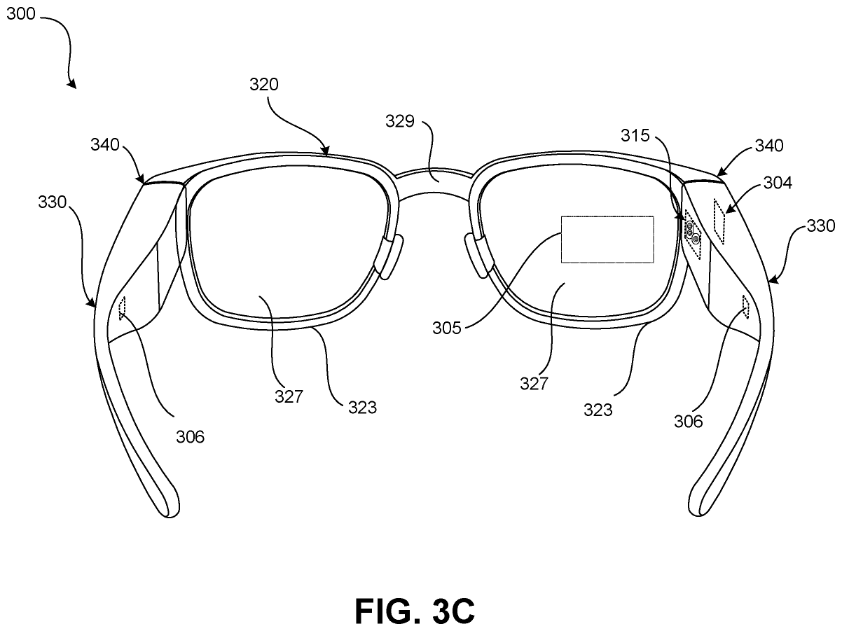

FIG. 3A illustrates a user wearing an example wearable device 300 in the form of smart glasses, or augmented reality glasses, including display capability, eye/gaze tracking capability, and computing/processing capability. FIG. 3B is a front view, and FIG. 3C is a rear view, of the example wearable device 300 shown in FIG. 3A. The example wearable device 300 includes a frame 310. The frame 310 includes a front frame portion 320, and a pair of arm portions 330 rotatably coupled to the front frame portion 320 by respective hinge portions 340. The front frame portion 320 includes rim portions 323 surrounding respective optical portions in the form of lenses 327, with a bridge portion 329 connecting the rim portions 323. The arm portions 330 are coupled, for example, pivotably or rotatably coupled, to the front frame portion 320 at peripheral portions of the respective rim portions 323. In some examples, the lenses 327 are corrective/prescription lenses. In some examples, the lenses 327 are an optical material including glass and/or plastic portions that do not necessarily incorporate corrective/prescription parameters.

In some examples, the wearable device 300 includes a display device 304 that can output visual content, for example, at an output coupler 305, so that the visual content is visible to the user. In the example shown in FIGS. 3B and 3C, the display device 304 is provided in one of the two arm portions 330, simply for purposes of discussion and illustration. Display devices 304 may be provided in each of the two arm portions 330 to provide for binocular output of content. In some examples, the display device 304 may be a see-through near eye display. In some examples, the display device 304 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 327, next to content (for example, digital images, user interface elements, virtual content, and the like) output by the display device 304. In some implementations, waveguide optics may be used to depict content on the display device 304.

In some examples, the wearable device 300 includes one or more of an audio output device 306 (such as, for example, one or more speakers), an illumination device 308, a sensing system 311, a control system 312, at least one processor 314, and an outward facing image sensor 316 (for example, a camera). In some examples, the sensing system 311 may include various sensing devices (e.g., an always-on sensing device, always-on camera, always-on IMU, and/or the like) and the control system 312 may include various control system devices including, for example, one or more processors 314 operably coupled to the components of the control system 312. In some examples, the control system 312 may include a communication module providing for communication and exchange of information between the wearable device 300 and other external devices.

In some examples, the wearable device 300 includes a gaze tracking device 315 to detect and track eye gaze direction and movement. The gaze tracking device 315 can include a backward facing camera and a LED. As mentioned above, wearable devices (e.g., the wearable device 300) can have strict requirements on power consumption, industrial design, manufacturability, and/or the like. Therefore, the gaze tracking device 315 can be restricted to minimal camera and LED quantities. Data captured by the gaze tracking device 315 may be processed to detect and track gaze direction and movement as a user input. In the example shown in FIGS. 3B and 3C, the gaze tracking device 315 is provided in one of the two arm portions 330, simply for purposes of discussion and illustration. In the example arrangement shown in FIGS. 3B and 3C, the gaze tracking device 315 is provided in the same arm portion 330 as the display device 304, so that user eye gaze can be tracked not only with respect to objects in the physical environment, but also with respect to the content output for display by the display device 304. In some examples, gaze tracking devices 315 may be provided in each of the two arm portions 330 to provide for gaze tracking of each of the two eyes of the user. In some examples, display devices 304 may be provided in each of the two arm portions 330 to provide for binocular display of visual content.

Numerous different sizing and fitting measurements and/or parameters may be considered when selecting and/or sizing and/or fitting a wearable device, such as the example wearable device 300 shown in FIGS. 3A-3C, for a particular user. This may include, for example, wearable fit parameters, or wearable fit measurements. Wearable fit parameters/measurements may consider how a particular frame 310 fits and/or looks and/or feels on a particular user. Wearable fit parameters/measurements may take into consideration numerous factors such as, for example, whether the rim portions 323 and bridge portion 329 are shaped and/or sized so that the bridge portion 329 rests comfortably on the bridge of the user's nose, whether the frame 310 is wide enough to be comfortable with respect to the temples, but not so wide that the frame 310 cannot remain relatively stationary when worn by the user, whether the arm portions 330 are sized to comfortably rest on the user's ears, and other such comfort related considerations. Wearable fit parameters/measurements may consider other as-worn considerations including how the frame 310 may be positioned based on the user's natural head pose/where the user tends to naturally wear his/her glasses. In some examples, aesthetic fit measurements or parameters may consider whether the frame 310 is aesthetically pleasing to the user/compatible with the user's facial features, and the like.

In a wearable device including display capability, display fit parameters, or display fit measurements may be considered in selecting and/or sizing and/or fitting the wearable device 300 for a particular user. Display fit parameters/measurements may be used to configure the display device 304 for a selected frame 310 for a particular user, so that content output by the display device 304 is visible to the user. For example, display fit parameters/measurements may facilitate calibration of the display device 304, so that visual content is output within at least a set portion of the field of view of the user. For example, the display fit parameters/measurements may be used to configure the display device 304 to provide at least a set level of gazability, corresponding to an amount, or portion, or percentage of the visual content that is visible to the user at a periphery (for example, a least visible corner) of the field of view of the user.

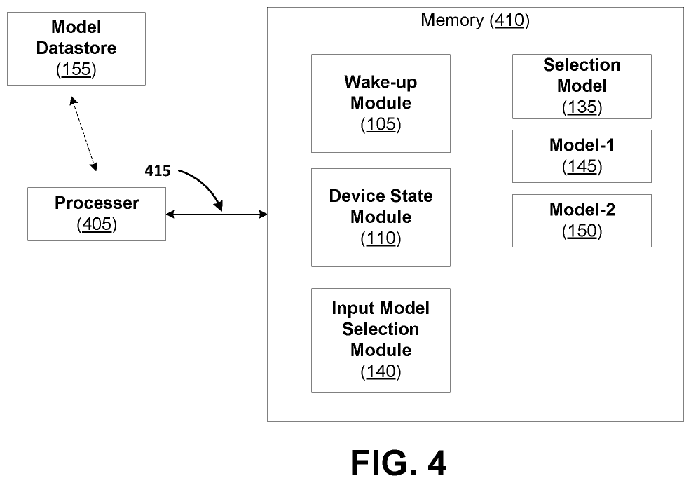

FIG. 4 illustrates a block diagram of a system according to an example implementation. In the example of FIG. 4, the system (e.g., the wearable device 300, an augmented reality system, a virtual reality system, a companion device, and/or the like) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 405 and a memory 410 (e.g., a non-transitory computer readable memory). The processor 405 and the memory 410 can be coupled (e.g., communicatively coupled) by a bus 415.

The processor 405 may be utilized to execute instructions stored on the at least one memory 410. Therefore, the processor 405 can implement the various features and functions described herein, or additional or alternative features and functions. The processor 405 and the at least one memory 410 may be utilized for various other purposes. For example, the at least one memory 410 may represent an example of various types of memory and related hardware and software which may be used to implement any one of the modules described herein.

The at least one memory 410 may be configured to store data and/or information associated with the device. The at least one memory 410 may be a shared resource. Therefore, the at least one memory 410 may be configured to store data and/or information associated with other elements (e.g., image/video processing or wired/wireless communication) within the larger system. Together, the processor 405 and the at least one memory 410 may be utilized to implement the techniques described herein. As such, the techniques described herein can be implemented as code segments (e.g., software) stored on the memory 410 and executed by the processor 405. Accordingly, the memory 410 can include any combination of the wake-up module 105, the device state module 110, the input model selection module 140, the selection model 135, the model-1 145, and the model-2 150.

The example implementation shown in FIG. 4 is only one example hardware configuration. In other implementations operations can be shared between the wearable device and other communicatively coupled computing devices. For example, at least one block can be performed on a companion computing device (e.g., a mobile phone) and/or a web-based device (e.g., a server). For example, the input model selection module 140 and the model datastore 155 could be implemented on a companion computing device (e.g., a mobile phone) and/or a web-based device (e.g., a server). Therefore, the wearable device can be configured to communicate and/or receive data to/from the companion computing device (e.g., a mobile phone) and/or the web-based device (e.g., a server). As mentioned above, to minimize memory usage the model datastore 155 can be included in, for example, the companion computing device and/or a web-based device that is communicatively coupled (illustrated as a dashed line) with the wearable device.

Implementations can include one or more, and/or combinations thereof, of the following examples.

Example 1: FIG. 2 illustrates a method for waking-up a wearable device according to an example implementation. The method can include sensing, by a wearable device, device context as a contextual cue, selecting, by the wearable device, a trained input model based on the contextual cue, generating, by the wearable device, a feature representation based on a wake-up cue using the input model, and predicting, by the wearable device, a wake-up trigger based on the feature representation.

Example 2: The method of Example 1 can further include causing the wearable device to transition from an inactive state to an active state based on the wake-up trigger.

Example 3: The method of Example 1, wherein the sensing of the device context can include capturing an image by a camera (e.g., an always-on camera) of the wearable device.

Example 4: The method of Example 1, wherein the input model can be selected from a datastore including a plurality of trained models each configured to sense the wake-up cue with a different time step for processing the wake-up cue.

Example 5: The method of Example 1, wherein the wake-up trigger can be predicted using a trained neural network including the input model, the neural network can be or can include a convolutional neural network (CNN) long short-term memory (LSTM) model, the input model can be or can include the CNN, and the wake-up trigger can be predicted by the LSTM.

Example 6: The method of Example 1, wherein the wearable device can be a smart glasses.

Example 7: The method of Example 1, wherein the input model can be selected from a datastore included in a remote device that is communicatively coupled with the wearable device. The datastore can include a plurality of trained models.

Example 8: The method of Example 1, wherein the input model can be configured to distinguish between a background signal and the wake-up cue.

Example 9: The method of Example 1, wherein the wake-up cue can be a sensed double tap of the wearable device, the sensed double tap can include a sensed first tap and a sensed second tap, and the wake-up trigger can be predicted based on a time period between the sensed first tap and the sensed second tap.

Example 10: The method of Example 1, wherein the wake-up cue can be a sensed double tap of the wearable device, the input model can be or can include a CNN, training the CNN can include receiving a training wake-up cue session including a plurality of possible wake-up cues, windowing the training wake-up cue session to generate a windowed wake-up cue, determining whether the windowed wake-up cue includes a double tap signal, and in response to determining the windowed wake-up cue includes the double tap signal, training the CNN using the windowed wake-up cue.

Example 11. A method can include any combination of one or more of Example 1 to Example 10.

Example 12. A non-transitory computer-readable storage medium comprising instructions stored thereon that, when executed by at least one processor, are configured to cause a computing system to perform the method of any of Examples 1-11.

Example 13. An apparatus comprising means for performing the method of any of Examples 1-11.

Example 14. An apparatus comprising at least one processor and at least one memory including computer program code, the at least one memory and the computer program code configured to, with the at least one processor, cause the apparatus at least to perform the method of any of Examples 1-11.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the included figures can include sensors that interface with an AR headset/HMD device to generate an augmented environment for viewing inserted content within the physical space. For example, one or more sensors included on a computing device or other computing device depicted in the figure, can provide input to the AR headset or in general, provide input to an AR space. The sensors can include, but are not limited to, a touchscreen, accelerometers, gyroscopes, pressure sensors, biometric sensors, temperature sensors, humidity sensors, and ambient light sensors. The computing device can use the sensors to determine an absolute position and/or a detected rotation of the computing device in the AR space that can then be used as input to the AR space. For example, the computing device may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device when the computing device is incorporated into the AR space can cause a particular action to occur in the AR space.

In some implementations, one or more output devices included on the computing device can provide output and/or feedback to a user of the AR headset in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device may appear as another object in a computer-generated, 3D environment. Interactions by the user with the computing device (e.g., rotating, shaking, touching a touchscreen, swiping a finger across a touch screen) can be interpreted as interactions with the object in the AR space. In the example of the laser pointer in an AR space, the computing device appears as a virtual laser pointer in the computer-generated, 3D environment. As the user manipulates the computing device, the user in the AR space sees movement of the laser pointer. The user receives feedback from interactions with the computing device in the AR environment on the computing device or on the AR headset. The user's interactions with the computing device may be translated to interactions with a user interface generated in the AR environment for a controllable device.

Computing device described herein can represent and/or be communicatively coupled to various forms of digital computers and devices, including, but not limited to laptops, desktops, workstations, personal digital assistants, servers, blade servers, mainframes, and other appropriate computers.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
sensing, by a wearable device, device context as a contextual cue;
selecting, by the wearable device, a trained input model based on the contextual cue;
generating, by the wearable device, a feature representation based on a wake-up cue using the input model; and
predicting, by the wearable device, a wake-up trigger based on the feature representation.

2. The method of claim 1, further comprising:
causing the wearable device to transition from an inactive state to an active state based on the wake-up trigger.

3. The method of claim 1, wherein the sensing of the device context includes capturing an image by a camera of the wearable device.

4. The method of claim 1, wherein the input model is selected from a datastore including a plurality of trained models each configured to sense the wake-up cue with a different time step for processing the wake-up cue.

5. The method of claim 1, wherein,
the wake-up trigger is predicted using a trained neural network including the input model,
the neural network includes a convolutional neural network (CNN) long short-term memory (LSTM) model,
the input model includes the CNN, and
the wake-up trigger is predicted by the LSTM.

6. The method of claim 1, wherein the wearable device is a smart glasses.

7. The method of claim 1, wherein the input model is selected from a datastore included in a remote device that is communicatively coupled with the wearable device.

8. The method of claim 1, wherein the input model is configured to distinguish between a background signal and the wake-up cue.

9. The method of claim 1, wherein,
the wake-up cue is a sensed double tap of the wearable device,
the sensed double tap includes a sensed first tap and a sensed second tap, and
the wake-up trigger is predicted based on a time period between the sensed first tap and the sensed second tap.

10. The method of claim 1, wherein,
the wake-up cue is a sensed double tap of the wearable device,
the input model includes a CNN,
training the CNN includes,
receiving a training wake-up cue session including a plurality of possible wake-up cues,
windowing the training wake-up cue session to generate a windowed wake-up cue,
determining whether the windowed wake-up cue includes a double tap signal, and
in response to determining the windowed wake-up cue includes the double tap signal, training the CNN using the windowed wake-up cue.

11. A wearable device comprising:
at least one processor; and
at least one memory including computer program code;
the at least one memory and the computer program code configured to, with the at least one processor, cause the wearable device to:
sense wearable device context as a contextual cue;
select a trained input model based on the contextual cue;
generate a feature representation based on a wake-up cue using the input model; and
predict a wake-up trigger based on the feature representation.

12. The wearable device of claim 11, wherein the computer program code is further configured to cause the wearable device to:
transition from an inactive state to an active state based on the wake-up trigger.

13. The wearable device of claim 11, wherein the sensing of the device context includes capturing an image by a camera of the wearable device.

14. The wearable device of claim 11, wherein the input model is selected from a datastore including a plurality of trained models each configured to sense the wake-up cue with a different time step for processing the wake-up cue.

15. The wearable device of claim 11, wherein,
the wake-up trigger is predicted using a trained neural network including the input model,
the neural network includes a convolutional neural network (CNN) long short-term memory (LSTM) model,
the input model includes the CNN, and
the wake-up trigger is predicted by the LSTM.

16-18. (canceled)

19. The wearable device of claim 11, wherein,
the wake-up cue is a sensed double tap of the wearable device,
the sensed double tap includes a sensed first tap and a sensed second tap, and
the wake-up trigger is predicted based on a time period between the sensed first tap and the sensed second tap.

20. The wearable device of claim 11, wherein,
the wake-up cue is a sensed double tap of the wearable device,
the input model includes a CNN,
training the CNN includes,
receiving a training wake-up cue session including a plurality of possible wake-up cues,
windowing the training wake-up cue session to generate a windowed wake-up cue,
determining whether the windowed wake-up cue includes a double tap signal, and
in response to determining the windowed wake-up cue includes the double tap signal, training the CNN using the windowed wake-up cue.

21. A non-transitory computer-readable storage medium comprising instructions stored thereon that, when executed by at least one processor, are configured to cause a computing system to:
sense, by a wearable device, device context as a contextual cue;
select, by the wearable device, a trained input model based on the contextual cue;
generate, by the wearable device, a feature representation based on a wake-up cue using the input model; and
predict, by the wearable device, a wake-up trigger based on the feature representation.

22-24. (canceled)

25. The non-transitory computer-readable storage medium of claim 21, wherein,
the wake-up trigger is predicted using a trained neural network including the input model,
the neural network includes a convolutional neural network (CNN) long short-term memory (LSTM) model,
the input model includes the CNN, and
the wake-up trigger is predicted by the LSTM.

26-28. (canceled)

29. The non-transitory computer-readable storage medium of claim 21, wherein,
the wake-up cue is a sensed double tap of the wearable device,
the sensed double tap includes a sensed first tap and a sensed second tap, and
the wake-up trigger is predicted based on a time period between the sensed first tap and the sensed second tap.

30. The non-transitory computer-readable storage medium of claim 21, wherein,
the wake-up cue is a sensed double tap of the wearable device,
the input model includes a CNN,
training the CNN includes,
receiving a training wake-up cue session including a plurality of possible wake-up cues,
windowing the training wake-up cue session to generate a windowed wake-up cue,
determining whether the windowed wake-up cue includes a double tap signal, and
in response to determining the windowed wake-up cue includes the double tap signal, training the CNN using the windowed wake-up cue.
